(19) United States
(12) Patent Application Publication
(10) Pub. No.: US 2021/0154625 A1
(43) Pub. Date: May 27, 2021

(54) THIN FILM NANOCOMPOSITE MEMBRANES CONTAINING METAL-ORGANIC CAGES FOR DESALINATION

(71) Applicant: National University of Singapore, Singapore (SG)

(72) Inventors: Dan ZHAO, Singapore (SG); Guoliang LIU, Singapore (SG); Yidi YUAN, Singapore (SG)

(21) Appl. No.: 17/045,784

(22) PCT Filed: May 2, 2019
(86) PCT No.: PCT/SG2019/050246

§ 371 Date: Oct. 7, 2020

(30) Foreign Application Priority Data
May 2, 2018 (SG) 10201803639

(51) Int. Cl. B01D 69/12; C02F 1/44; B01D 71/56

(52) U.S. Cl. CPC B01D 69/12; B82Y 30/00; B01D 71/56; C02F 1/44

(57) ABSTRACT

Disclosed herein is a composite material comprising a complex of formula I: {[Cp₃M₃O(OH)₃]₄(A)₆}(I), wherein A represents a ligand of formula II, and a polyamide. There is also disclosed a thin film nanocomposite membrane, a method of manufacturing the composite material and a method of purifying brackish water or seawater with the thin film nanocomposite membrane.

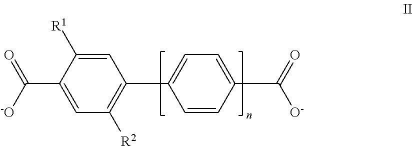

### FIELD OF INVENTION

Disclosed herein is a composite material, which may be used in a thin film nanocomposite membrane for desalination.

### BACKGROUND

The listing or discussion of a prior-published document in this specification should not necessarily be taken as an acknowledgement that the document is part of the state of the art or is common general knowledge.

Water scarcity is a serious global challenge which can be addressed by providing a sustainable way to desalinate seawater and brackish water. The conventional methods for desalination include distillation and reverse osmosis (RO). The RO process uses thin-film composite (TFC) membranes comprising a semipermeable polyamide (PA) layer on a porous support substrate, where the polyamide layer is formed by an interfacial polymerisation reaction involving amine and acid chloride monomers. While the RO process involves a lower energy consumption compared to other techniques such as distillation, improvement of membrane water permeance is critical to reduce the required membrane area and the operating pressure, so as to improve the energy efficiency.

Incorporating a nanoporous filler, such as NaA zeolites, metal-organic frameworks (MOFs), and covalent organic frameworks (COFs) into the PA selective layer is one approach to improve the separation performance of the membrane. Typically, the resultant thin film nanocomposite (TFN) membranes may exhibit enhanced water permeability because water molecules passing through the separation layer may partially flow across the porous fillers with decreased hydraulic resistance. However, the salt rejection typically drops, which can be attributed to the voids formed between the fillers and the PA matrix caused by poor compatibility and dispensability of the fillers (Lau, W. J. et al., Water Res. 2015, 80, 306-24).

EP 2209546 A1 mentions use of zeolite nanoparticles as a filler in TFN membranes. US 20140367326 A1 mentions use of mesoporous silica nanoparticles. US 20100025330 A1, US 20100206811 A1, and US 20130015122 A1 mention use of carbon nanotubes and derivatives. However, the insolubility of the above-mentioned fillers in the interfacial polymerisation system and poor compatibility with polyamide increase the risk of defect formation in the membranes.

In addition, the filler size also affects the membrane performance (Jadav, G. L. et al., J. Membr. Sci. 2009, 328 (1-2), 257-267). Hence, the ideal candidate fillers should possess a suitable pore size to allow the passage of water molecules with full rejection of hydrated ions, as well as a uniform and small size to increase the compatibility and dispersibility within the PA layer.

U.S. Pat. No. 9,333,465 B2 relates to thin film composite membranes embedded with molecular cage compounds with inner diameters larger than water (e.g. calixarene—˜0.5 nm, α-cyclodextrin—˜4.5-5.7 nm, POSS—0.3-0.4 nm). However, these cage compounds are not ionic in nature (which means they are not favourable for water transport) and have relatively large aperture size that may affect the rejection of hydrated ions.

Surface modification has been investigated to enhance the hydrophilicity of fillers and improve their dispersibility in aqueous phase as well as the interfacial compatibility with the polymer (Lee, H. D.; et al., Small 2014, 10 (13), 2653-60). However, it involves complicated processes that may not be able to scale-up easily (Guo, X. et al., AlChE J. 2017, 63 (4), 1303-1312).

Metal-organic cages (MOCs) constructed from metal ions or clusters with organic ligands are discrete porous molecules with uniform yet tunable molecular size and aperture size, exhibiting interesting applications in building hierarchical structures, cavity-induced catalysis, stabilisation of reactive intermediates and metastable materials, host-guest chemistry, and gas sorption. Unlike extended porous materials such as zeolites, MOFs and COFs, the solubility of MOCs offer many advantages for processing into thin films and as selective additives in TFN membranes reaching molecular level distribution with maximum compatibility (Dechnik, J. et al., Angew. Chem. Int. Ed. 2017, 56 (32), 9292-9310). However, for the above features to be efficiently exploited in desalination application, the chosen MOCs should be water-stable with a high acid resistance to survive during the fabrication process of TFN membranes, as hydrochloric acid will be released during the interfacial polymerisation (Karan, S. et al., Science 2015, 348 (6241), 1347-51; Van Goethem. et al., J. Membr. Sci. 2018, 563, 938-948).

There is therefore a need for improved materials and methods that solve one or more of the problems mentioned above.

### SUMMARY OF INVENTION

Aspects and embodiments of the invention are provided by the following numbered clauses.

1. A composite material comprising:
a complex of formula I:

{[Cp₃M₃O(OH)₃]₄(A)₆} I,
where:
M represents Zr, Hf or Ti;
A represents a ligand of formula II:

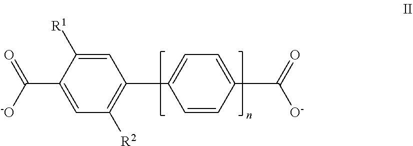

R¹ and R² represents H, OH, NHR³, SH or C₁₋₆ alkyl substituted with OH, SH or NHR³; and
R³ represents C₁₋₆ alkyl;
n represents 0 or 1;
where each of the oxygen atoms in the carboxylate groups are bound to an M atom; and
a polyamide, wherein:
when at least one or R¹ and R² is not H, the complex of formula I is covalently bonded by way of an O, N or S atom in the R¹ or R² group of the moiety of formula II to the polyamide;

or
when R¹ and R² are both H, the complex of formula I is homogeneously distributed throughout the polyamide without covalent bonding.

2. The composite material according to Clause 1, wherein in the compound of formula II, M is Zr.

3. The composite material according to Clause 1 or Clause 2, wherein the complex of formula I is covalently bonded to the polyamide.

4. The composite material according to any one of the preceding clauses, wherein the ligand of formula II is selected from the group consisting of:

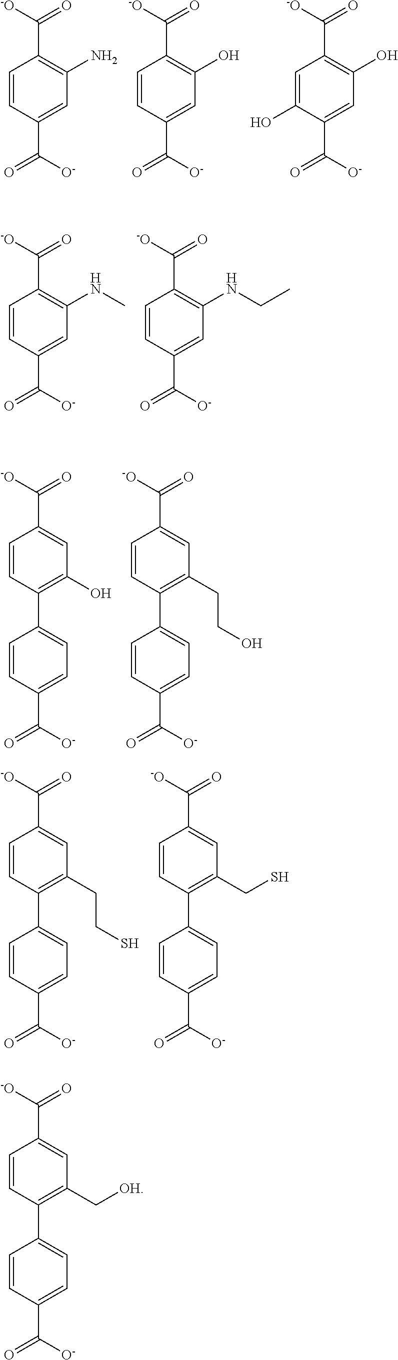

5. The composite material according to Clause 4, wherein the ligand of formula II is:

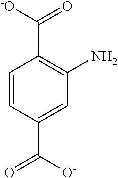

6. The composite material according to any one of the preceding clauses, wherein the composition further comprises a moiety that is covalently bonded to the polyamide, which moiety is derived from a compound selected from one or more of the group consisting of:

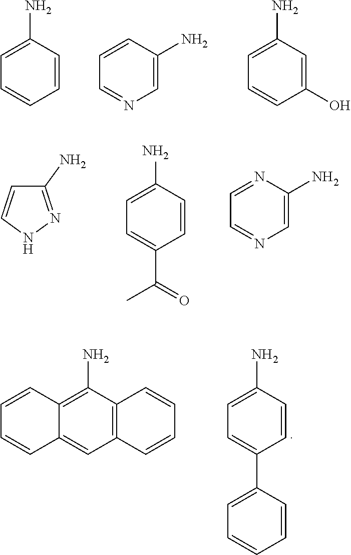

7. The composite material according to any one of the preceding clauses, wherein the polyamide is a polymeric network formed by the reaction of a polyamine with a polyfunctional acid halide, optionally wherein:
the polyamine is selected from one or more of the group consisting of diaminobenzene, triaminobenzene, m-phenylene diamine, p-phenylene diamine, 1,3,5-diaminobenzoic acid, 2,4-diaminotoluene, 2,4-diaminoanisole, xylylene-diamine, ethylenediamine, propylenediamine, piperazine, and tris(2-diaminoethyl)amine; and/or
the polyfunctional acid halide is selected from one or more of the group consisting of trimesoyl chloride, trimellitic acid chloride, isophthaloyl chloride, and terephthaloyl chloride.

8. The composite material according to Clause 7, wherein the polyamine is meta-phenylenediamine and the polyfunctional acid halide is trimesoyl chloride.

9. The composite material according to any one of the preceding clauses, wherein the composite material is provided as a thin film.

10. The composite material according to any one of the preceding clauses, wherein the complex of formula I has:

an aperture size of from 1.76 Å to 5.04 Å, such as from 2.30 Å, 4.3 Å, and 3.73 Å; and/or
a cavity size of from 8.2 Å to 13.0 Å, such as from 9 to 10 Å.

11. A thin film nanocomposite membrane comprising:
a substrate material; and
a thin film formed on a surface of the substrate, wherein the thin film material is a composite material according to any one of Clauses 1 to 10.

12. The nanocomposite membrane according to Clause 11, wherein the substrate material comprises:

a non-woven fabric support; and

a porous layer of polysulfone and/or polyethersulfone on top of the non-woven fabric support, where the thin film is formed on the porous layer of polysulfone and/or polyethersulfone.

13. The nanocomposite membrane according to Clause 11 or Clause 12, wherein the water flux is greater than or equal to 3.52 LMH/bar and/or the salt rejection is greater than or equal to 95%.

14. A method of manufacturing a composite material, wherein the method comprises the steps of:
(a) providing a first solution comprising a first polyamide precursor reactant, a first solvent and a complex of formula I as described in any one of Clauses 1 to 10;
(b) providing a second solution comprising a second polyamide precursor reactant and a second solvent; and
(c) reacting the first solution with the second solution to form a polyamide.

15. The method according to Clause 14, wherein the complex of formula I is one where at least one of R¹ and R² is not H, so as to form a composite material where the complex of formula I is covalently bonded to the polyamide.

16. The method according to Clause 15, wherein the reaction step is an interfacial polymerisation reaction between the first solution and the second solution, so as to form a thin film.

17. The method according to Clause 16, wherein a substrate material is provided, such that the polymerisation reaction between the first solution and the second solution occurs on the surface of a substrate material to form a thin film nanocomposite membrane.

18. The method according to Clause 14, wherein the complex of formula I is one where both of R¹ and R² are H, so as to provide a composite material where the complex of formula I is homogeneously distributed throughout the polyamide without covalent bonding, optionally wherein the reaction step is an interfacial polymerisation reaction between the first solution and the second solution, so as to form a thin film.

19. The method according to Clause 18, wherein the process further comprises providing a substrate, such that the thin film material is formed on a surface of the substrate to form a thin film nanocomposite membrane.

20. The method according to Clause 17 or Clause 19, wherein the substrate material comprises polysulfone and/or polyethersulfone.

21. A method of purifying brackish water or seawater comprising contacting the brackish water or seawater with a thin film nanocomposite membrane according to any one of Clauses 11 to 13.

### DRAWINGS

Certain embodiments of the present disclosure are described more fully hereinafter with reference to the accompanying drawings.

FIG. 1. (a) The crystal structure of ZrT-1-NH₂ (central ball indicates internal cavity); (b) The solvent accessible surface of ZrT-1-NH₂ highlighting the aperture size.

FIG. 2. Schematic illustration for the fabrication of thin film nanocomposite membranes containing MOCs and their application in reverse osmosis desalination.

FIG. 3. Surface and cross-sectional FE-SEM images of TFC (a, e), 0.01%-TFN (b, f), 0.02%-TFN (c, g), and 0.04%-TFN (d, h). Scale bar denotes 100 nm.

FIG. 4. Water flux and salt rejection ratio as a function of ZrT-1-NH₂ concentration in the selective polyamide layer of the nanocomposite membrane.

FIG. 5. (a) The MPD and ZrT-1-NH₂ in acetone and water for membrane fabrication; (b) FT-IR characterisation for TFC, TFN-0.02, TFN-0.04, TFN-0.06 membranes; (c, d) XPS analysis of ZrT-1-NH₂, TFC and TFN-0.02 membranes; The FE-SEM images of top surface of polyamide TFC and TFN membranes: (e) TFC, (f) TFN-0.02, (g) TFN-0.04, and (h) TFN-0.06. Scale bar denotes 100 nm.

FIG. 6. AFM images of TFC (a, e); TFN-0.02 (b, f); TFN-0.04 (c, g); and TFN-0.06 (d, h) membranes. The measure scale is 5 μm for a-d and 2 μm for e-h.

FIG. 7. FE-SEM micrographs of cross-section for TFC and TFN membranes with different ZrT-1-NH₂ loading: (a) TFC, (b) TFN-0.02, (c) TFN-0.04 and (d) TFN-0.06. Scale bar denotes 100 nm.

FIG. 8. Illustration of the model reaction between ZrT-1-NH₂ and benzoyl chloride (a) and the reaction was traced by ESI-TOF-MS (b).

FIG. 9. (a) Permeation property of TFC and TFN membranes; and (b) permeance property of TFC and TFN membranes modulated with 2-aminopyrazine (2000 ppm NaCl).

FIG. 10. Schematic illustration of the fabrication of thin film composite polyamide membrane via (a) interfacial polymerisation and (b) “defect-ligand” stategy (b).

FIG. 11. Mono amino compounds used to tune the performance of TFC membrane.

FIG. 12. Performance of TFC membranes modulated with different ratios of 2-aminopyrazine.

### DESCRIPTION

It has been surprisingly found that the incorporation of a metal-organic cage material into a polyamide provides a composite material with improved properties that may overcome one or more of the issues identified above. The resulting material may be particularly suitable for use as part of a thin film composite (TFC) membrane for reverse water osmosis. For example, when the composite material is incorporated into a TFC membrane, the water permeability of the membrane may be improved when compared to a TFC membrane without the metal-organic framework material, while also retaining or improving on the latter material's salt rejection properties.

Thus, disclosed in a first aspect of the invention, there is provided a composite material comprising:
a complex of formula I:

{[Cp₃M₃O(OH)₃]₄(A)₆} I,
where:
M represents Zr, Hf or Ti
A represents a ligand of formula II:

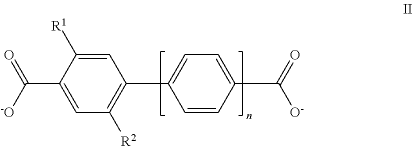

R¹ and R² represents H, OH, NHR³, SH or C₁₋₆ alkyl substituted with OH, SH or NHR³; and
R³ represents C₁₋₆ alkyl;
n represents 0 or 1;
where each of the oxygen atoms in the carboxylate groups are bound to an M atom; and
a polyamide, wherein:
when at least one or R¹ and R² is not H, the complex of formula I is covalently bonded by way of an O N or S atom in the R¹ or R² group of the ligand of formula II to the polyamide;

or
when R¹ and R² are both H, the complex of formula I is homogeneously distributed throughout the polyamide without covalent bonding.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The polyamide may be provided in any suitable form, such as a semi-permeable polyamide polymeric matrix or, more particularly as a semi-permeable polyamide film matrix. The polyamide polymer matrix can be a three-dimensional polymer network such as an aliphatic or aromatic polyamide, aromatic polyhydrazide, poly-bensimidazolone, polyepiamine/amide, polyepiamine/urea, poly-ethyleneimine/urea, sulfonated polyfurane, polybenzimidazole, polypiperazine isophtalamide, a polyether, a polyether-urea, a polyester, or a polyimide or a copolymer thereof or a mixture thereof. The polyamide may be formed by the reaction of a polyamine with a polyfunctional acid halide. Any suitable polyamine and polyfunctional halide may be used to form the polyamide.

Examples of suitable polyamines include, but are not limited to diaminobenzene, triaminobenzene, m-phenylene diamine, p-phenylene diamine, 1,3,5-diaminobenzoic acid, 2,4-diaminotoluene, 2,4-diaminoanisole, xylylene-diamine, ethylenediamine, propylenediamine, piperazine, and tris(2-diaminoethyl)amine. Suitable polyfunctional acid halides include but are not limited to trimesoyl chloride, trimellitic acid chloride, isophthaloyl chloride, and terephthaloyl chloride. As will be appreciated, one of more polyamines and one or more polyfunctional acid halides may be used to form the polyamide (e.g. in the form of a polyamide polymer matrix or, more particularly, a polyamide polymer matrix film). In particular examples disclosed herein, the polyamine may be meta-phenylenediamine and the polyfunctional acid halide may be trimesoyl chloride.

As will be appreciated from the foregoing, the composite material can be provided in the form of a thin film. When used herein, the term “thin film” when used to refer to the composite material, is intended to refer to a material in the form of one or more layered sheets of material having a thickness of from 100 to 500 nm, such as from 100 to 300 nm.

The complex of formula I is a metal organic cage (MOC). MOCs are constructed from metal ions, or clusters of ions, with organic ligands and are discrete, porous molecules with uniform (yet tunable) molecular size, aperture size and cavity size. When used herein, the term “aperture size” refers to the diameter of the holes (or cage windows) in the MOC and the term “cavity size” refers to the diameter of the inner space enclosed by the cage structure of the MOC.

In the complex of formula I, any suitable aperture size may be used. Examples of suitable aperture sizes include, but are not limited to a size of from of from 1.76 Å to 5.04 Å (e.g. from 3 to 5 Å), such as from 2.30 Å, 4.3 Å, and 3.73 Å. Without wishing to be bound by theory, it is believed that an aperture size of less than or equal to 5.04 Å will preferentially exclude hydrated metal (e.g. sodium) ions, which have a kinetic diameter that is greater than 6 Å due to size-exclusion effect. Thus, the MOCs used herein are expected to show an enhanced selectivity for water over other materials if used in the purification of brackish water. In addition, the cavity of the complex of formula I may be viewed as a “highway” for molecular transportation (e.g. water molecules), while keeping larger hydrated materials out (e.g. hydrated sodium ions). Any suitable cavity size may be used, for example, the cavity size may be from 8.2 Å to 13.0 Å, such as from 9 to 10 Å. Without wishing to be bound by theory, it is believed that the cavity size of the MOCs disclosed herein (i.e. complexes of formula I) may be influenced by the size of the ligands of formula II (e.g. number of aryl ring systems present) and the presence of pendant functional groups.

When used in the complex of formula I, the abbreviation “Cp” refers to a cyclopentadienyl anion (i.e. C₅H₅⁻), which is coordinated to a metal ion, M. The metal ion M may be selected from one of Zr, Hf or Ti. For example, the metal ion M may be Zr.

As noted above, the composite material may be one in which the complex of formula I is either covalently bonded by way of an O, N or S atom in the R¹ or R² group of the ligand of formula II to the polyamide (i.e. at least one of R¹ and R² is not H) or the complex of formula I is homogeneously distributed throughout the polyamide without covalent bonding (i.e. when both R¹ and R² are H). In particular embodiments that may be described herein, the complex of formula I is covalently bonded to the polyamide. As will be appreciated, when the complex of formula I is covalently bonded to the polyamide, at least one of R¹ and R² is not H, but is rather selected from OH, NHR³, SH or C₁₋₆ alkyl substituted with OH, SH or NHR³. This is because at least one functional atom selected from O, N and S is required to form a covalent bond to the polyamide material.

Unless otherwise stated, the term “alkyl” refers to an unbranched or branched, saturated or unsaturated (so forming, for example, an alkenyl or alkynyl) acyclic hydrocarbyl radical, which is unsubstituted (with, for example, one or more halo atoms). The term “alkyl” may refer a C₁₋₆ alkyl group, such as a C₁₋₄ alkyl group (such as ethyl, propyl, (e.g. n-propyl or isopropyl), butyl (e.g. branched or unbranched butyl), pentyl or methyl). In certain embodiments of the invention that may be mentioned herein, the alkyl group is saturated.

While the ligand of formula II is shown having two carboxylate groups (in anionic form), it will be understood that in the complex these anionic groups are complexed to the cationic metal ions M. Without wishing to be bound by theory, it is believed that the clusters of di-topic carboxylate ligands present in the MOCs described herein may impart the MOCs with excellent stability and compatibility toward various functional groups due to the strong interactions between the metal cations (e.g. Zr cations) and the carboxylate-containing ligands.

As noted above, the ligand of formula II is capable of forming at least one covalent bond (e.g. 2, 3, 4, or 5 or, more particularly 1) to with the polyamide material. This may be achieved by adding the complex of formula I (each complex of which contains six ligands of formula II) to a reaction mixture comprising one or more polyamines and one or more polyfunctional acid halides to form a composite material where the complex of formula I is covalently bonded to the resulting polyamide material. As will be appreciated, one or more of the free OH, SH or NHR³ groups on a ligand of formula II may react with a polyfunctional acid halide to form an ester, thioester or amide covalent bond, which thereby anchors the complex of formula I to the polyamide material. Further details of the methods used to manufacture the composite material where the complex of formula I is covalently bonded to the polyamide are provided in the experimental section below. In embodiments of the invention where the composite material involves a covalent bond between the complex of formula I and the polyamide, then an advantage that may be present is that the complex of formula I may not leak or may exhibit reduced leakage compared to other materials that may be added to a polyamide material. When used herein, the term “leakage” is intended to refer to the leeching of the complex of formula I from the composite material (e.g. when comparing a composite material having covalent bonds between the complex of formula I and the polyamide and a composite material having the same components, but without the covalent linkages).

Suitable ligands of formula II that may be used herein include, but are not limited to:

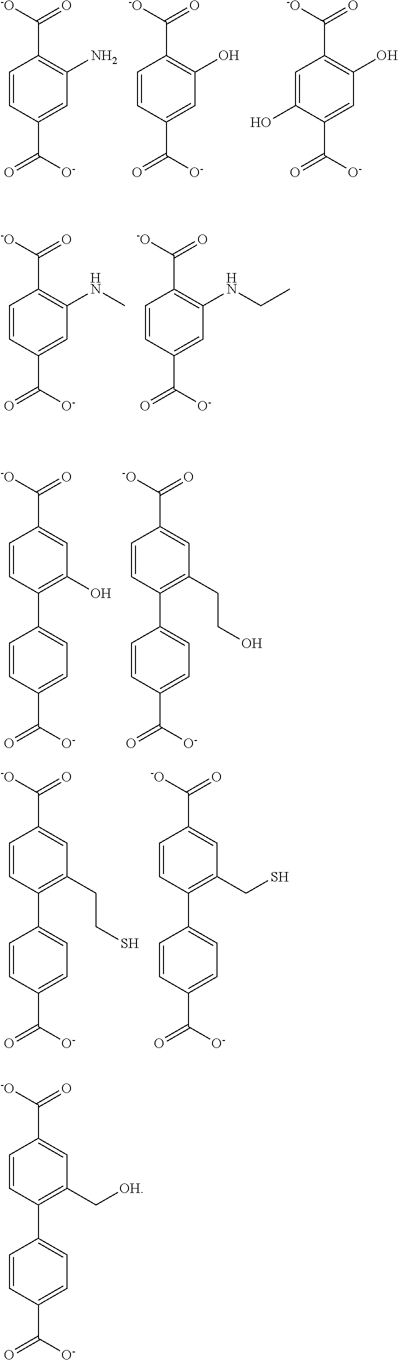

In particular embodiments that may be disclosed herein, the ligand of formula II may be:

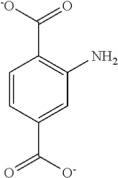

It is noted that the complexes of formula I (e.g. ZrT-1-NH₂) can be easily synthesized at gram scale in one hour with an environmentally friendly method, which helps to indicate the potential industrial applications for these complexes. As demonstrated herein, the MOC complexes of formula I, which can be made from readily commercially available chemicals, can be used to enhance the desalination performance of reverse osmosis thin film membranes, thereby showing its potential for use in energy-efficient industrial separations (e.g. reverse osmosis desalination and other suitable separations).

Advantageously, the complexes of formula I mentioned herein are soluble in solvents that are typically used for the conduct of interfacial polymerisation reactions. For example, the complexes of formula I disclosed herein may be soluble in hexane or more particularly acetone and water (or a combination of acetone and water in any suitable v/v ratio). Additionally, the complexes of formula I (i.e. MOCs, such as Zr-MOCs) disclosed herein may be of nanometer size, which is below the typical thickness of the polyamide selective layer of a thin film composite membrane. This ensures that the MOCs (e.g. Zr-MOCs) disclosed herein can be fully embedded and well dispersed within the polyamide layer, reducing the formation of defects during the membrane fabrication process. Further, the introduction of ionic MOCs (e.g. Zr-MOCs) into such thin film composite membranes may improve the hydrophilicity of the membranes, potentially leading to an increased water flux for the fabricated membranes.

In certain embodiments, it may be desired to modify the permeability and the salt rejection level by the addition of one or more additive materials. Such additive materials may be aromatic mono-amine compounds that can covalently bond into the polyamide matrix in a manner that introduces a “defect” into the polyamide structure by acting as a chain termination group. Suitable polyamides include, but are not limited to:

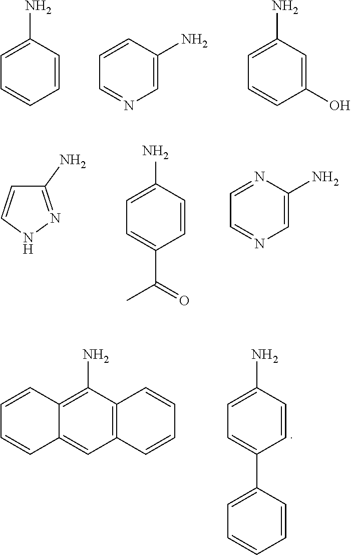

Particular examples of such monoamines that may be mentioned for use in the current invention are 2-aminopyrazine, 3-aminopyridine, and 4-aminopyridine. The monoamine may be introduced into a reaction mixture comprising one or more polyamines and one or more polyfunctional acid halides in a suitable molar fraction (e.g. from 0.001 to 0.5, such as from 0.01 to 0.3, such as from 0.1 to 0.2) compared to the polyamine component, so as to form the desired defects in the composite material. As will be appreciated, the complex of formula I may also be introduced in the same step, when it is desired to have the complex of formula I covalently bonded to the polyamide. As will be appreciated by the person skilled in the art, the amount of the desired monoamine (or mixture of monoamines) used to form the composite material may be selected so as to maximise the desired properties (e.g. flux and salt rejection percentage) of the final composite material.

As will be appreciated, the composite material disclosed herein may be particularly suited for use in the formation of a thin film nanocomposite membrane. Thin film composite (TFC) membranes are particularly useful in reverse osmosis (RO). Such membranes typically comprise a substrate material and a semi-permeable polymer film polymerized on the porous polymeric support. The semi-permeable or discriminating film is typically a polyamide.

Thus, in a further aspect of the invention, there is also disclosed a thin film nanocomposite membrane comprising:
a substrate material; and
a thin film formed on a surface of the substrate, wherein the thin film material is a composite material as described hereinbefore.

The thin film portion of the TFC is formed from the composite material described hereinbefore, which material comprises a polyamide and a complex of formula I, which is either covalently bonded to the polyamide (i.e. at least one of R¹ and R² is not H) or is homogeneously distributed throughout the polyamide but is not covalently bonded (i.e. R¹ and R² are H). In particular embodiments of the invention, the complex of formula I is covalently bonded to the polyamide material.

The substrate material may be any suitable substrate material and may comprise one or more components. For example, TFC membranes typically comprise a porous layer of polysulfone and/or polyethersulfone, which material may also be used herein. In addition, it is common for a non-woven material to be used as a support for the porous layer of polysulfone and/or polyethersulfone. Thus, in an embodiment of the invention, the substrate material may comprise:

a non-woven fabric support; and

a porous layer of polysulfone and/or polyethersulfone on top of the non-woven fabric support, where the thin film is formed on the porous layer of polysulfone and/or polyethersulfone.

It will be appreciated that the composite material described herein is formed on top of the porous layer of polysulfone and/or polyethersulfone when in the form of a thin film nanocomposite membrane. While polysulfone and/or polyethersulfone are mentioned herein it is noted that other porous polymeric materials may be suitable for use as the porous polymeric layer and these are contemplated herein as potential replacements for polysulfone and/or polyethersulfone. The porous layer polysulfone and/or polyethersulfone may have any suitable thickness, such as from 100 to 250 μm. The porous layer may be formed by any method known in the art or hereafter developed, including dispersion casting, immersion-precipitation and non-solvent-induced phase inversion. For example in dispersion casting, the porous layer of polysulfone and/or polyethersulfone may be formed by pouring an aliquot of a solution containing the desired polymer(s) onto a surface and removing the solvent. Increased temperature and/or reduced pressure can facilitate removal. The use of a non-solvent (a solvent with low affinity for the polymer) can be particularly effective in providing the porous layer of polysulfone and/or polyethersulfone.

The non-woven fabric support may be formed from any suitable material. For example, the non-woven fabric support may be a non-woven polyester fabric or other suitable polymeric, natural or synthetic material, such as carbon cloth.

The nanocomposite membranes of the current invention may display properties of a water flux of greater than or equal to 3.52 LMH/bar and/or a salt rejection of greater than or equal to 95% when used in reverse osmosis. It will be appreciated that the nanocomposite membranes disclosed herein may also be used in any other suitable application, such as forward osmosis or in fuel cells. However, the nanocomposite materials disclosed herein may be particularly suited for use in reverse osmosis. Thus, there is also disclosed herein a method of purifying brackish water or seawater comprising contacting the brackish water or seawater with a thin film nanocomposite membrane as described herein. The process of water purification with a reverse osmosis membrane is well known in the art, with suitable methods of achieving desalination using reverse osmosis described in more detail in the experimental section below.

The composite material may be formed by any suitable means. For example, in an aspect of the invention, the composite material describe hereinbefore may be formed by the steps comprising:
(a) providing a first solution comprising a first polyamide precursor reactant and a solvent and a complex of formula I as described hereinbefore;
(b) providing a second solution comprising a second polyamide precursor reactant and a solvent; and
(c) reacting the first solution with the second solution to form a polyamide.

The polyamide and polyamine mentioned in the method above may be selected from one or more of those mentioned hereinbefore.

The first and second solvents may be miscible with one another or may be immiscible with one another, depending on whether there is a desire to use interfacial polymerisation or not.

As will be appreciated, the process described above is intended to cover the situation where the complex of formula I becomes covalently bonded to the resulting polyamide or where the complex of formula I is merely dispersed within the polyamide homogeneously. It will be appreciated that it would be possible to form a composite material containing both covalently bonded and dispersed materials (without covalent bonding) by the use of two different complexes of formula I (i.e. one where at least one of R¹ and R² is not H and one where both are H). In embodiments of the invention that may be mentioned herein, the complex of formula I used may be one where at least one of R¹ and R² is not H, so as to form a composite material where the complex of formula I is covalently bonded to the polyamide.

In embodiments of the invention, where it is desired to manufacture a polymer film of the composite material, the reaction step described above may be an interfacial polymerisation reaction between the first solution and the second solution. As will be appreciated, in this embodiment the first and second solvents will be selected to be immiscible with one another. For example, the first solvent may be water or a combination of water and acetone in any suitable amount (e.g. a v/v ratio of acetone to water of 3:2), while the second solvent may be an organic solvent that is immiscible with water, such as hexanes (n-hexane and its branched isomers) or n-hexane.

As will be appreciated, the use of interfacial polymerisation may be particularly suited to the manufacture of a thin film nanocomposite membrane (e.g. a reverse osmosis membrane). Thus in embodiments of the invention where a thin film nanocomposite membrane is desired, the process may further comprise conducting the interfacial polymerisation reaction between the first solution and the second solution in such a way that it occurs on the surface of a substrate material to form a reverse osmosis membrane. The substrate material may comprise a non-woven fabric support and a porous layer of polysulfone and/or polyethersulfone on top of the non-woven fabric support—where the thin film is formed on the porous layer of polysulfone and/or polyethersulfone. Further details of how to manufacture the substrate material are provided hereinabove.

In alternative embodiments of the invention where the complex of formula I is one where R¹ and R² are both H, then the resulting product of the process will be a material where the complex of formula I is simply homogeneously dispersed within the polyamide (and not covalently bonded thereto). If a thin film of the resulting composite material is desired, then the process may be conducted using interfacial polymerisation, as described above.

Further aspects and embodiments of the invention are provided in the following non-limiting examples.

### EXAMPLES

Zirconium metal-organic cages (Zr-MOCs) were used as a filler to fabricate thin film nanocomposite (TFN) membranes. The Zr-MOCs were embedded in an ultra-thin polyamide layer via interfacial polymerisation reaction over a polymeric substrate. The incorporation of Zr-MOCs is beneficial for water-based separations such as reverse osmosis desalination, where the resulting membranes exhibited enhanced water flux and increased salt rejection rate.

Material and Method

All the reagents were obtained from commercial suppliers and used without further purification.

Zirconocene dichloride (Cp₂ZrCl₂, >99%, Aladdin), 2-aminoterephthalic acid (H₂—NH₂—BDC), and N,N-dimethylacetamide (DMA) were used for the synthesis of ZrT-1-NH₂.

m-Phenylenediamine (MPD, >99%, Sigma-Aldrich) and trimesoyl chloride (TMC, 98%, Sigma-Aldrich) were empolyed to synthesise the polyamide selective layer.

n-Hexane (>99%, Merck) was used as the solvent to dissolve TMC.

Sodium chloride solution (2000 ppm) was prepared by dissolving 1 g of sodium chloride (NaCl, Merck) in 500 mL of deionised water (DI).

A Milli-Q unit (Millipore, USA) was used to supply DI water.

A Bruker Alfa ATR-FTIR was used to collect IR absorption spectra from 400 to 4000 cm⁻¹, averaged over 64 scans.

Field-emission scanning electron microscope (FE-SEM) analyses were conducted on a FEI Quanta 600 SEM (20 kV) equipped with an energy dispersive spectrometer (EDS, Oxford Instruments, 80 mm² detector). Samples were treated via Pt sputtering before observation.

Atomic force microscopy (AFM) was carried out by testing samples using tapping mode with a Bruker Dimension Icon atomic force microscope.

¹H NMR spectra were recorded on a Variant/Agilent 600 MHz NMR spectrometry. The deuterated solvents used are indicated in the experimental part; and chemical shifts are given in ppm from TMS with residual solvent resonances as internal standards.

High resolution electrospray ionisation mass spectrometry (ESI-TOF-MS) were recorded on a MaXis™ 4G instrument from Bruker. Data analyses were conducted with the Bruker Data Analysis software (Version 4.0); and simulations were performed with the Bruker Isotope Pattern software.

The salt concentration was detected by a conductivity meter (Lab 955, Schott Instruments).

X-ray photoelectron spectroscopy (XPS) spectra were collected on a Kratos AXIS UltraDLD surface analysis instrument using a monochromatic Al Kα radiation (1486.71 eV) at 15 kV as the excitation source. The takeoff angle of the emitted photoelectrons was 90° (the angle between the plane of sample surface and the entrance lens of the detector). Peak position was corrected by referencing the C 1s peak position of adventitious carbon (284.6 eV), and shifting all other peaks in the spectrum accordingly.

General Procedure 1. Preparation of ZrT-1-NH₂

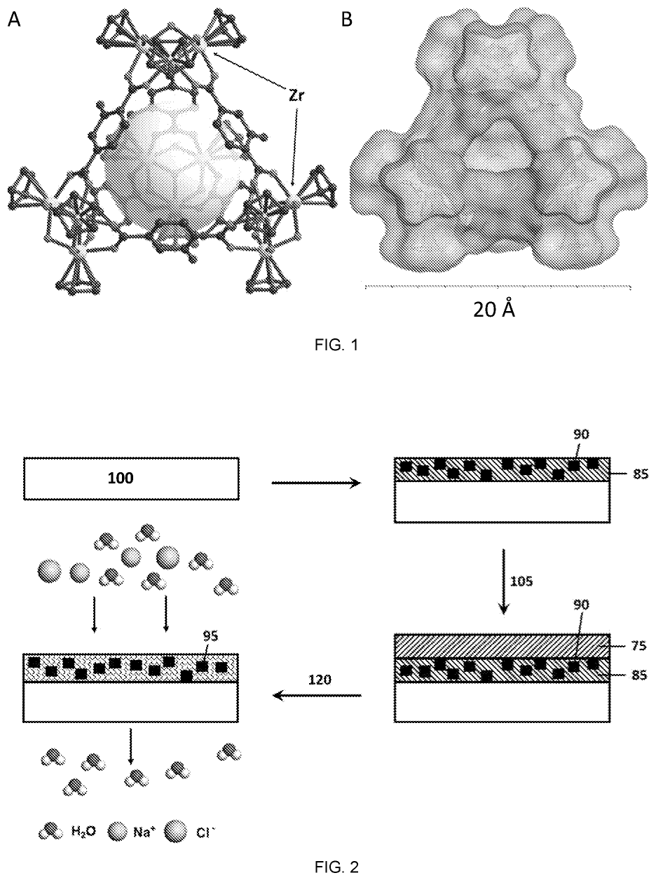

ZrT-1-NH2, as a representative metal-organic cage (FIG. 1, was prepared based on a previously reported procedure (D. Nam, et al., Chem. Sci. 2017, 8, 7765).

In a typical procedure, 2-aminoterephthalic acid (0.005 g, 0.03 mmol) and zirconocene dichloride (0.015 g, 0.05 mmol) were reacted in N,N-dimethylacetamide (DMA, 1.0 mL) with a trace amount of water (4 drops) at 65° C. for 4 h. The product was washed with 3 aliquots of 3 mL of tetrahydrofuran and dimethylformamide each before isolated as yellow cubic block crystals with a yield of about 80%.

Elemental analysis: calc. (%) for {[Cp₃Zr₃O(OH)₃]₄(NH₂—BDC)₆}.Cl₄.14DMA.36H₂O, C 37.67, H 5.78, N 5.36; found (%): C 37.52, H 5.45, N 5.46. ESI-Q-TOF-MS (MeOH): The following selected signals are those at the highest intensities. m/z Calcd for [M-4Cl-3H)]¹+3214.3538, found 3214.4557; [M-4Cl-2H)]²⁺ 1607.6792, found 1607.7315; Calcd for [M-4Cl-H)]³⁺1072.1214, found 1072.1567; Calcd for [M-4C1]¹+804.3428, found 804.3694. FT-IR (KBr, 4000-400 cm⁻¹): 3385(s), 1625(s), 1549(vs), 1438(s), 1389(s), 1258(s), 1019(s), 821(s), 765(s), 618(s), 575(s), 469(s).

Discussion of Characterisation Results

The successful preparation of ZrT-1-NH₂ was confirmed by high resolution electrospray ionisation mass spectrometry (ESI-TOF-MS), the confirmation of which indicated the high stability of ZrT-1-NH₂ under aqueous environment as water was used to dissolve the sample. Some peaks with lower intensity can be ascribed to the cages with encapsulated water molecules, suggesting the accessibility of cage voids to water molecules.

Single crystal X-ray diffraction study indicates the formation of a coordination cage with a V₄E₆ (V: vertex; E: edge) topology. The molecular size of ZrT-1-NH₂ was determined to be about 2 nm and the aperture size of ZrT-1-NH₂ was determined to be about 3.73 Å, which is larger than a water molecule (2.7 Å) and smaller than a hydrated sodium ion (7.16 Å), indicating the possibility of using ZrT-1-NH₂ as an additive to incorporate into thin film composite membranes for desalination application. Besides, the amino functional group of Zr—NH₂—BDC may also participate in the interfacial polymerisation and chemically bind to the thin film composite membranes.

### Example 1. Preparation of Thin Film Nanocomposite (TFN) Membranes Containing ZrT-1-NH₂

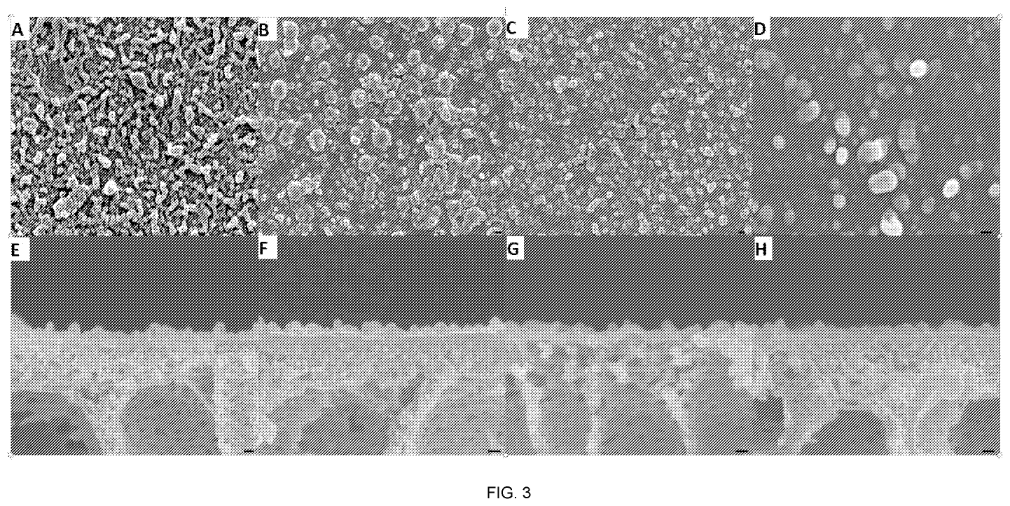

Thin film nanocomposite (TFN) membranes containing ZrT-1-NH₂ were prepared by interfacial polymerisation of a polyamide membrane on the polyethersulfone (PES) substrate (FIG. 2). Considering the low solubility of ZrT-1-NH₂ in pure water, a mixed solvent containing acetone and water (3:2 v/v) was used for membrane fabrication.

In a typical procedure, the PES ultrafiltration membrane (100) was exposed to 1 mL of 2 wt % m-phenylenediamine (MPD; 85) acetone/water (3:2 v/v) solution containing ZrT-1-NH₂ (0.01, 0.02 and 0.04 w/v % of each; as prepared from General procedure 1; 90) for 2 min. Excess MPD solution remaining on the PES substrate was removed by filter paper. After drying in air for 1 min, the PES substrate was immersed (105) in 1 mL of 0.15 w/v % 1,3,5-benzenetricarbonyl trichloride (TMC; 75) in n-hexane for 1 min to form a polyamide layer (95) via interfacial polymerisation (120). The excess TMC was removed by washing with hexane. Lastly, the membrane was dried in air for 10 min and stabilised in DI water for 90 min to give a x %-TFN membrane, where x denotes the % of ZrT-1-NH₂ in the MPD solution.

Preparation of Thin Film Composite (TFC) Membrane as Control

Thin film composite (TFC) membrane was prepared by hand-casting a bare polyamide membrane (without ZrT-1-NH₂) on the polysulfone (PES) substrate. The polyamide membrane was also formed via interfacial polymerisation reaction between MPD and TMC. In other words, TFC was prepared by repeating the procedure above, but using a m-phenylenediamine (MPD) acetone/water solution with no ZrT-1-NH₂.

Surface Morphology of Resulting Membranes

The surface morphology of the resulting membranes was characterised by field-emission scanning electron microscopy (FE-SEM). The FE-SEM images of the top and cross sectional area of thin film composite membranes (TFC) and thin film nanocomposite membranes (TFN) are shown in FIG. 3, indicating the formation of a selective layer with a thickness of around 200 nm. The TFC membrane has a rough and leaf-like surface morphology that is typical among polyamide membrane. After adding the ZrT-1-NH₂ additive, however, the morphology of the top surface greatly changes and become smooth and dense.

### Example 2. Permeation Performance of Membranes as Prepared from Example 1

The TFN and TFC membranes as prepared in Example 1 were tested for their permeation property in desalination tests using NaCl solution (2000 ppm).

Procedure

Membrane permeation performance was measured with a nanofiltration cell. Agitation speed was kept constant at 350 rpm to minimize concentration polarization during filtration process.

The membrane effective area was 19.6 cm², and the permeation test was conducted at 25° C. and 15.5 bar. Prior to the permeation testing, each membrane was first compacted at 15.5 bar with a feed solution for 20 minutes to obtain a steady flux.

Results

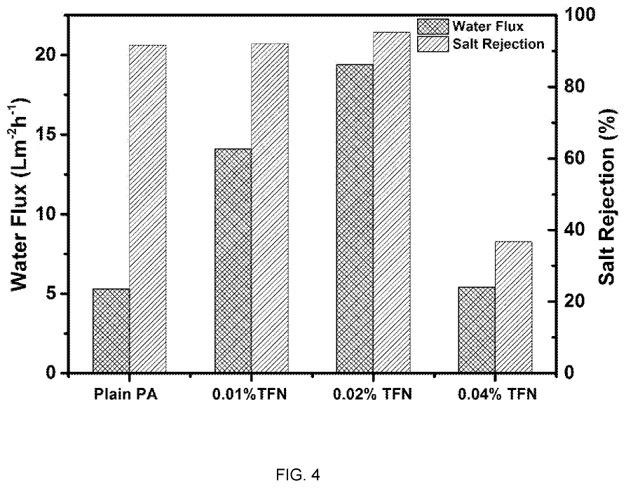

Adding ZrT-1-NH₂ to the polyamide selective layer increases both water flux and salt rejection (FIG. 4). The water flux increased by 250% after adding 0.04% of ZrT-1-NH₂. The NaCl rejection also increased from 91% (TFC) to 95% (0.04-TFN). The water flux enhancement can be attributed to the enhanced porosity and polarity induced by adding ZrT-1-NH₂. Salt rejection enhancement probably results from the formation of a denser membrane as shown in FIG. 3.

### Example 3. Optimised Preparation of Thin Film Nanocomposite (TFN) Membranes Containing ZrT-1-NH₂ and the Characterisation Thereof

TFN membranes were prepared by interfacial polymerisation on a commercially available polysulfone (PSF) substrate (Foglia, F. et al., Adv. Fund. Mater. 2017, 27 (37), 1701738).

In a typical procedure, the PSF substrate is exposed into 1 mL of acetone/water solution (v/v=3:2) containing 2 wt % of 1,3-phenyldiamine (MPD) and varying amounts of ZrT-1-NH₂ (as prepared in General procedure 1) for 2 min, after which the excess solution was removed by filter paper. The PSF substrate was then fixed onto a frame (so that interfacial polymerisation reaction happened only at its top surface), and 1 mL solution of 0.15% (w/v) 1,3,5-benzenetricarbonyl trichloride (TMC) in n-hexane was introduced for the interfacial polymerisation. After 1 min of reaction, the resultant membrane was washed with n-hexane to remove the residue on the membrane surface followed by copious washing with deionised water. The synthesised TFN membrane was denoted as TFN-X, where X indicates ZrT-1-NH₂ loading of 0.02, 0.04, and 0.06% (w/v), respectively.

TFC membrane without ZrT-1-NH₂ was also prepared using the above procedure except that no ZrT-1-NH₂ was added in the solution with MPD. The TFC and TFN membranes were kept in deionised water before membrane performance test.

Characterisation

Color Changes, FTIR and XPS Analysis

A color change from white to lightly yellow was observed between the TFC and TFN membranes, serving as preliminary evidence for the successful incorporation of ZrT-1-NH₂.

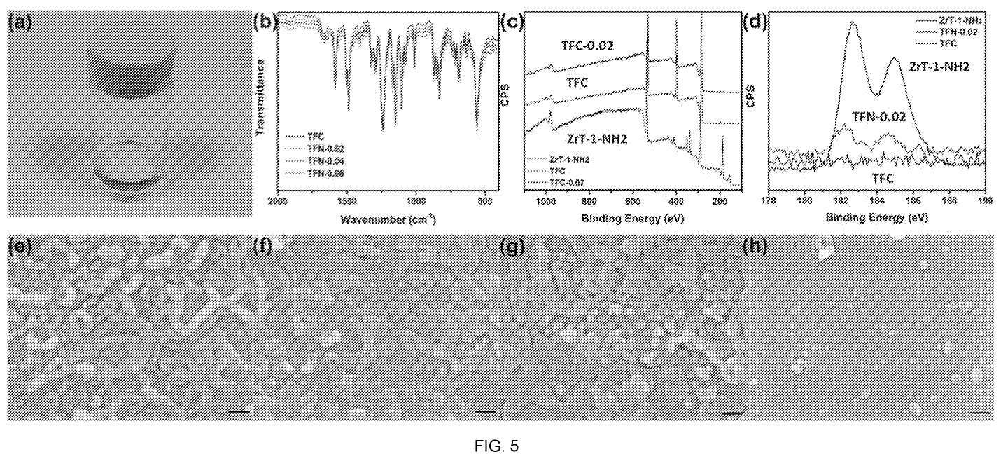

ATR-FTIR analysis reflects the characteristic C═O bending at 1610 cm⁻¹ and the amide band at 1540 cm⁻¹, confirming the successful formation of polyamide (PA) in both the TFC and ZrT-1-NH₂ decorated TFN membranes (FIG. 5b). Due to the small amounts of filler, the presence of ZrT-1-NH₂ is difficult to be detected via ATR-FTI R. Accordingly, the presence of Zr (3 d) signal in X-ray photoelectron spectra (XPS) measurements performed on the TFN-0.02 membrane was used to confirm the successful incorporation of the filler (FIGS. 5c and 5d).

Field-Emission Scanning Electron Microscopy (FE-SEM) and Atomic Force Microscopy (AFM)

The surface morphology and surface roughness of the TFC and TFN membranes were characterised by using field-emission scanning electron microscopy (FE-SEM) and Atomic force microscopy (AFM).

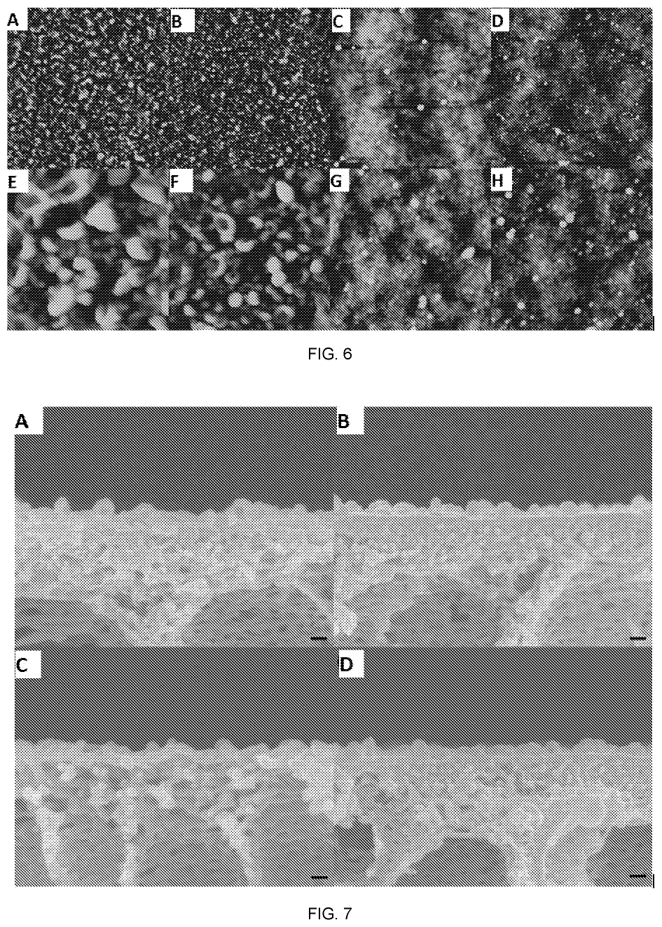

The FE-SEM images of the top surface of TFC and TFN membranes are shown in FIG. 5e-g. The TFC membrane had a rough and leaf-like morphology that is a peculiar feature of the PA membrane surface, which may be caused by local temperature rise resulting from high-rate polymerisation reaction. However, the morphology of the top surface greatly changed and became smooth after adding the ZrT-1-NH₂ additives. The decreased surface roughness is apparent in the AFM images (FIG. 6), which further indicated decreasing root mean squared roughness (Rq) values as a function of ZrT-1-NH₂ concentration (Table 1). The thickness of TFC and TFN membranes were estimated from the cross-sectional FE-SEM images (FIG. 7). The average thickness of the PA layer is about 100 nm considering the maximum and minimum thickness simultaneously.

TABLE 1
Root mean squared (Rq) value of TFC and TFN membranes.

| Rq (nm) | TFC | TFN-0.02 | TFN-0.04 | TFN-0.06 |
|---|---|---|---|---|
| 5 μm | 34.1 | 26.3 | 7.63 | 6.6 |

Crosslinking of ZrT-1-NH₂ into TFN Membranes

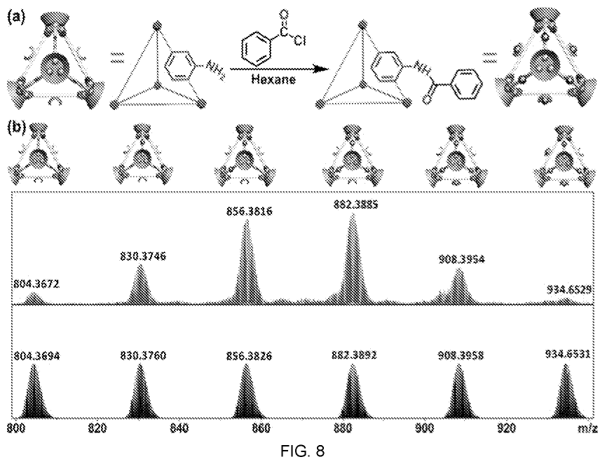

The pendant amino groups of ZrT-1-NH₂ suggest the possibility that the MOCs may participate in the interfacial polymerisation reaction between MPD and TMC. In order to verify this hypothesis, the reactivity of ZrT-1-NH₂ was investigated using a model condensation reaction using benzoyl chloride in hexane solvent (FIG. 8a). In a typical experiment, the ZrT-1-NH₂ is kept in 1 mL n-hexane while 20 uL benzoyl chloride is added thereafter. The reaction is allowed to proceed for about 1 h before the ZrT-1-NH₂ is washed with fresh aliquots of n-hexane. The sample is then dried in the fume hood. For the ESI-TOF-MS analysis, 2 mg of the dried ZrT-1-NH₂ is dissolved in acetone/water (3:2 v/v). The resulting ZrT-1-NH₂ solution is injected into the ESI-TOF-MS instrument port and the test range is 50-3000 m/z.

ESI-TOF-MS analysis revealed new peaks with normal distribution, suggesting the participation of the amino groups in the reaction. During the one-hour reaction period, the peaks gradually shifted to higher m/z value as more amino groups were functionalised (FIG. 8b, upper spectrum). Peak deconvolution indicates that benzoyl chloride take part in the reaction and amide was obtained. The isotopic distribution patterns of each peak are in good agreement with calculated values (FIG. 8b, bottom spectrum). ESI-TOF-MS analysis indicated that ZrT-1-NH₂ keep the framework intact during interfacial polymerisation process as hydrogen chloride was also released as during the model reaction. Therefore, ZrT-1-NH₂ may be chemically cross-linked into the TFN membrane during interfacial polymerisation process.

Membrane Hydrophilicity as a Function of ZrT-1-NH₂ Content

In a typical procedure, the contact angles of the TFC and TFN membranes were measured by depositing a drop of water on top of the the membrane fixed on a stage while a live video is taken. The contact angle is measured by a fitting software.

TFC membranes are relatively hydrophobic with a high contact angle (Bano, S. et al., J. Mater. Chem. A 2015, 3 (5), 2065-2071). The contact angle decreased with increasing ZrT-1-NH₂ content which is associated with an increase in surface hydrophilicity (Table 2), a recognised parameter for water flux enhancement. The increased hydrophilicity presumably arises from the ionic nature of the ZrT-1-NH₂ and the abundant amine functional groups (Emadzadeh, D. et al., Desalination 2015, 368, 106-113; Sorribas, S. et al., J. Am. Chem. Soc. 2013, 135 (40), 15201-8).

TABLE 2
Contact angle of TFC and TFN membranes.

| Membrane | Contact Angle |
|---|---|
| TFC | 88 ± 2 |
| TFN-0.02 | 75 ± 3 |
| TFN-0.04 | 67 ± 2 |
| TFN-0.06 | 51 ± 6 |

### Example 4. Permeation Performance of Membranes as Prepared from Example 3

To investigate the effect of ZrT-1-NH₂ on the permeance properties of a TFN membrane, the permeation performance of the TFN and TFC membranes (as prepared from Example 3) were measured for desalination using 2000 ppm NaCl solution as the feed solution.

Membrane Performance Testing Procedure

Membrane permeation performance was measured with a nanofiltration cell. Agitation speed was kept constant at 350 rpm to minimise concentration polarisation during filtration process. The membrane effective area was 19.6 cm², and the permeation test was conducted at 25° C. and 15.5 bar. Prior to the permeation testing, each membrane was first compacted at 15.5 bar with a feed solution for 20 minutes to obtain a steady flux. The flux was calculated by using the following eqn (1):

$$J = \frac{V}{S \times t} \qquad ( 1 )$$

where J is the flux (LMH, L m⁻² h⁻¹), V is the permeate volume (L), S is the membrane area (m²), and t is the time (h).

The solute rejection percentage was calculated using the following eqn (2):

$$Salt Rejection ( \% ) = ( 1 - \frac{{C}_{P}}{{C}_{f}} ) \times 100 \qquad ( 2 )$$

where, Cₚ and C_{f} are the concentration of permeate and feed solution respectively.

Results and Discussion

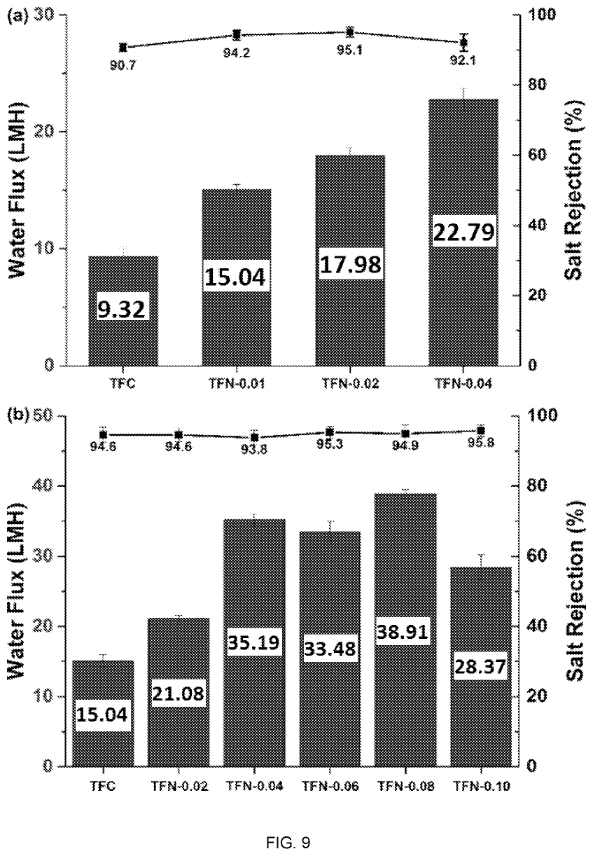

The permeation performance of TFN and TFC membranes are shown in FIG. 9a. The original TFC membrane showed a water flux of about 9.32 L m⁻² h⁻¹ (LMH). Up to 0.04 wt % loading, the measured water flux increased 93% to 17.98 LMH. The flux enhancement can be attributed to the enhanced porosity and hydrophilicity induced by adding ZrT-1-NH₂, which can cause the water sorption to increase and water diffusion resistance in TFN membrane to decrease. Smoothening of membrane surface decreases the effective surface area and generally leads to decreased water transport. However, this adverse effect is not observed for the smoothened ZrT-1-NH₂-TFN membrane. This suggests that the water flow through the new water pathways introduced by ZrT-1-NH₂ overwhelmed the decrease of water transport caused by smaller effective membrane surface area. The cavity of ZrT-1-NH₂ may be viewed as a “highway” for water molecular transportation while keeping the large hydrated sodium ions out. The voids between ZrT-1-NH₂ and PA layer should also play an important role to enhance the flux.

Meanwhile, the salt rejection reached a maximum at 95.1%, before declining to 92.1% at 0.06 wt % loading. The improvement in salt retention attests to the better compatibility between ZrT-1-NH₂ and PA matrix, resulting from the chemical crosslinking of ZrT-1-NH₂ and polyamide monomers, as well as favorable secondary interactions such as hydrogen bonding and electrostatic effects. Meanwhile, ZrT-1-NH₂ with larger size may prevent the penetration of MPD into the void in the PSF substrate. Without wishing to be bound by theory, it is believed that the use of higher amounts of ZrT-1-NH₂ during the interfacial polymerisation process will lead to agglomeration of ZrT-1-NH₂ on the top layer, inducing non-selective voids between the agglomerated ZrT-1-NH₂ particles and the PA layer, affecting the rejection performance.

### Example 5. Optimising Permeation Performance of TFN Membrane by Varying Crosslinking Density of the Polyamide Layer

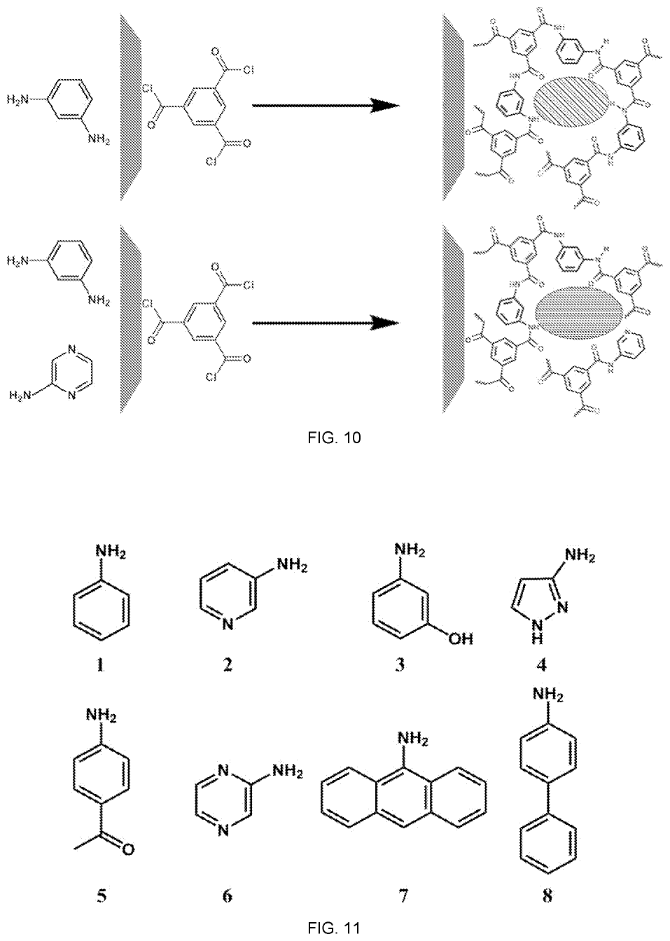

Although the TFN membrane showed enhanced performance at a lower doping range, performance decline was observed upon increasing the doping amount of the filler. This may be due to the rigidity of the polyamide that induced the low compatibility with the filler. Besides, the effective porosity of the filler may be reduced due to pore blockage by the dense polyamide layer. To improve the access of water molecules into the porous MOC fillers, a “defective-ligand” strategy was adopted to introduce defects into the TFN membranes (FIG. 10).

Combining Monoamine Ligands with MPD without ZrT-1-NH₂

To control the crosslinking density of the polyamide layer, TFC membranes were prepared according to Example 3 except that the 2 wt % of 1,3-phenyldiamine (MPD) was replaced with (2-x) wt % 1,3-phenyldiamine (MPD) and x wt % monoamine. The monoamine ligands tested are depicted in FIG. 11.

The performance of the fabricated membranes was tested according to the procedure in Example 4. 2-aminopyrazine (6 in FIG. 11) was found to improve the water permeability while maintaining a high salt rejection (Table 3).

TABLE 3
The performance of TFC membranes fabricated using MPD
in combination with different mono amino compounds.

| Monoamine | | | | | | | | |
|---|---|---|---|---|---|---|---|---|
| (FIG. 11) | 1 | 2 | 3 | 4 | 5 | 6 | 7 | 8 |
| Flux (LMH) | 9.3 | 18.2 | 13 | 8.2 | 8.8 | 15.9 | 18 | 10 |
| Rejection (%) | 93 | 75.7 | 75 | 92.3 | 88.3 | 94 | 46 | 80 |

Molar Ratio of MPD:2-Aminopyrazine

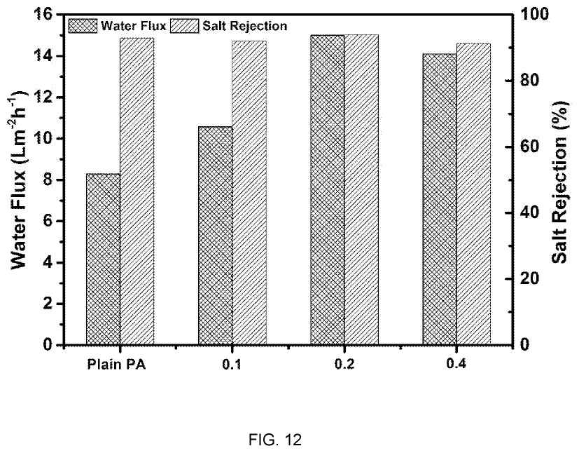

The quantity of 2-aminopyrazine was subsequently optimised to improve the membrane performance. When the MPD/2-aminopyrazine weight ratio was 4:1, i.e. 1.6 wt % MPD and 0.4 wt % 2-aminopyrazine, the best water permeability and selectivity for the TFC membrane were obtained, indicating that this ratio provided a reasonable cross-linking density (FIG. 12). The x-axis of FIG. 12 indicates the weight fraction of MPD being substituted by 2-aminopyrazine in the MPD/2-aminopyrazine solution.

FE-SEM and AFM was used to characterise the surface morphology of the TFC membranes modified with different amount of 2-aminopyrazine indicating the characteristic ridge-and-valley structure of the TFC membranes.

TFN Membranes Containing 2-Aminopyrazine and MPD with Different Amounts of ZrT-1-NH₂

Different amounts of ZrT-1-NH₂ were used to further tune the performance of TFC membrane that were fabricated with the combination of 20% 2-aminopyrazine and MPD. The fabricated membranes were named as TFN-82-0.02, TFN-82-0.04, TFN-82-0.06, TFN-82-0.08, and TFN-82-0.10 according to the ZrT-1-NH₂ content in the aqueous solution. These TFN membranes were fabricated according to Example 3, except that the 2 wt % MPD was replaced with 1.6 wt % MPD and 0.4 wt % 2-aminopyrazine. The resulting membranes were tested according to Example 4.

When 0.08% (w/v) ZrT-1-NH₂ was incorporated, the flux reached up to 38.8 LMH (3.2-fold higher compared to the original TFC membrane) while the salt rejection was maintained at about 94.9% (FIG. 9b). This enhancement was caused by a synergistic effect between the defective ligand strategy and ZrT-1-NH₂ facilitated water transportation strategy.

FE-SEM and AFM characterisation of the TFN-82 membranes indicated the membrane surface becoming smooth after adding ZrT-1-NH₂. To investigate the distribution of the ZrT-1-NH₂, the TFN-82-0.10 membrane was subjected to field-emission transmission electron microscopy (FE-TEM) analysis. The result indicated that the ZrT-1-NH₂ was homogeneously distributed in the polyamide layer.

1. A composite material comprising:
a complex of formula I:
{[Cp₃M₃O(OH)₃]₄(A)₆} I,
where:
M represents Zr, Hf or Ti
A represents a ligand of formula II: 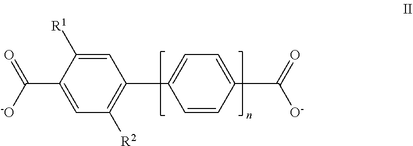
R¹ and R² represents H, OH, NHR³, SH or C₁₋₆ alkyl substituted with OH, SH or NHR³; and
R³ represents C₁₋₆ alkyl;
n represents 0 or 1;
where each of the oxygen atoms in the carboxylate groups are bound to an M atom; and
a polyamide, wherein:
when at least one of R¹ and R² is not H, the complex of formula I is covalently bonded by way of an O, N or S atom in the R¹ or R² group of the moiety of formula II to the polyamide; or
when R¹ and R² are both H, the complex of formula I is homogeneously distributed throughout the polyamide without covalent bonding.

2. The composite material according to claim 1, wherein in the compound of formula II, M is Zr.

3. The composite material according to claim 1, wherein the complex of formula I is covalently bonded to the polyamide.

4. The composite material according to claim 1, wherein the ligand of formula II is selected from the group consisting of:

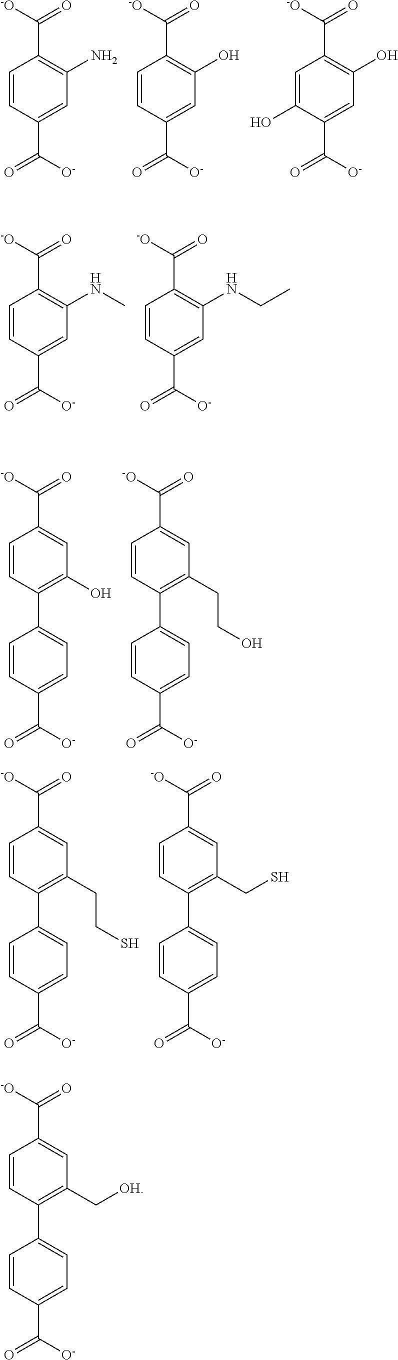

5. The composite material according to claim 4, wherein the ligand of formula II is:

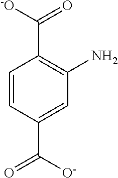

6. The composite material according to claim 1, wherein the composition further comprises a moiety that is covalently bonded to the polyamide, which moiety is derived from a compound selected from one or more of the group consisting of:

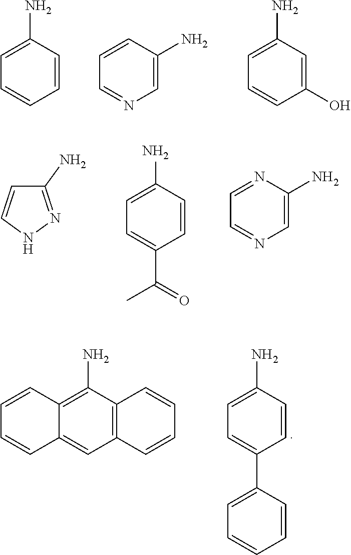

7. The composite material according to claim 1, wherein the polyamide is a polymeric network formed by the reaction of a polyamine with a polyfunctional acid halide.

8. The composite material according to claim 7, wherein the polyamine is meta-phenylenediamine and the polyfunctional acid halide is trimesoyl chloride.

9. The composite material according to claim 1, wherein the composite material is provided as a thin film.

10. The composite material according to claim 1, wherein the complex of formula I has one or both of the following features:
an aperture size of from 1.76 Å to 5.04 Å; and
a cavity size of from 8.2 Å to 13.0 Å.

11. A thin film nanocomposite membrane comprising:
a substrate material; and
a thin film formed on a surface of the substrate, wherein the thin film material is a composite material according to claim 1.

12. The nanocomposite membrane according to claim 11, wherein the substrate material comprises:
a non-woven fabric support; and
a porous layer of polysulfone and/or polyethersulfone on top of the non-woven fabric support, where the thin film is formed on the porous layer of polysulfone and/or polyethersulfone.

13. The nanocomposite membrane according to claim 11, wherein the water flux is greater than or equal to 3.52 LMH/bar and/or the salt rejection is greater than or equal to 95%.

14. A method of manufacturing a composite material, wherein the method comprises the steps of:
(a) providing a first solution comprising a first polyamide precursor reactant, a first solvent and a complex of formula I as described in claim 1;
(b) providing a second solution comprising a second polyamide precursor reactant and a second solvent; and
(c) reacting the first solution with the second solution to form a polyamide.

15. The method according to claim 14, wherein the complex of formula I is one where at least one of R¹ and R² is not H, so as to form a composite material where the complex of formula I is covalently bonded to the polyamide.

16. The method according to claim 15, wherein the reaction step is an interfacial polymerisation reaction between the first solution and the second solution, so as to form a thin film.

17. (canceled)

18. The method according to claim 14, wherein the complex of formula I is one where both of R¹ and R² are H, so as to provide a composite material where the complex of formula I is homogeneously distributed throughout the polyamide without covalent bonding.

19. The method according to claim 18, wherein the process further comprises providing a substrate, such that the thin film material is formed on a surface of the substrate to form a thin film nanocomposite membrane.

20. The method according to claim 17, wherein the substrate material comprises polysulfone and/or polyethersulfone.

21. A method of purifying brackish water or seawater comprising contacting the brackish water or seawater with a thin film nanocomposite membrane according to claim 11.
